(19) United States
(12) Patent Application Publication
(10) Pub. No.: US 2014/0250197 A1
(43) Pub. Date: Sep. 4, 2014

(54) CONTENT SERVER, TERMINAL, AND METHOD USING HTTP

(71) Applicant: SK TELECOM CO., LTD., Seoul (KR)

(72) Inventor: Woo Yong CHOI, Anyang-si (KR)

(73) Assignee: SK TELECOM CO., LTD., Seoul (KR)

(21) Appl. No.: 14/274,158

(22) Filed: May 9, 2014

Related U.S. Application Data
(63) Continuation of application No. PCT/KR2012/009385, filed on Nov. 8, 2012.

(30) Foreign Application Priority Data
Nov. 9, 2011 (KR) 10-2011-0116580

(51) Int. Cl. H04L 12/58; H04L 29/08

(52) U.S. Cl. CPC H04L 51/04; H04L 67/02
USPC 709/206

(57) ABSTRACT

The present disclosure relates to a file transfer system, server, terminal, and method using a hypertext transfer protocol (HTTP). A content server uploads a file from a transmitting terminal using an HTTP, and file link information on the uploaded file is transmitted to the transmitting terminal. The transmitting terminal transmits the file link information to a receiving terminal through a message server, and the receiving terminal downloads a corresponding file using the file link information. According to the present disclosure, since the receiving terminal efficiently downloads a file, based on a network environment or a resource state of the receiving terminal.

### CROSS REFERENCE TO RELATED APPLICATION

This application claims the priority of Korean Patent Application No. 10-2011-0116580, filed on Nov. 9, 2011, in the KIPO (Korean Intellectual Property Office). Further, this application is a continuation of International Application No. PCT/KR2012/009385, filed Nov. 8, 2012, claiming priority from the above mentioned Korean Patent Applications, and designating the United States. Each of the above listed applications is hereby incorporated by reference in their entirety into the present application.

### TECHNICAL FIELD

The present disclosure relates to a file transfer system, server, terminal, and method using a hypertext transfer protocol (HTTP), which when files are transferred between a transmitting terminal and a receiving terminal, allows the receiving terminal to be provided with the files using the HTTP without establishing a chatting session or file transfer session.

### BACKGROUND

The statements in this section merely provide background information related to the present disclosure and do not constitute prior art.

A variety of message services such as a short message service (SMS), a multimedia messaging service (MMS), and so on have been widely used. However, recently, an instant messaging (1M) service is actively being used instead of the SMS or MMS.

Advantageously, the IM service can provide a function of sending and receiving messages in almost real time, as compared to an electronic mail, in addition to a function of transferring texts and multimedia data. In the IM service, a session initiation protocol (SIP) is widely used as a type of a transmitting protocol for IM. The protocol is an application layer protocol used to establish, modify, and terminate multimedia communication sessions such as a voice over Internet protocol (VoIP). Meanwhile, a message session relay protocol (MSRP) is used as a protocol for transmitting and receiving data, in which data to be transmitted from a transmitting terminal to a receiving terminal is divided into several chunks and transmitted using an MSRP session.

However, in order to use the MSRP session to transfer a specific file, a call processing is previously performed using an SIP INVITE message, etc. Further, data packets relay all hops when the file is transferred using MSRP. Thus, network resources of terminals are inefficiently occupied.

In addition, it is difficult for both the transmitting terminal and the receiving terminal to sufficiently utilize their own bandwidths. Thus, the terminals inefficiently transfer files in some situations.

In particular, in a trend of a mobile communication that a network load is increased due to explosive increase in IM services, transferring data via a chatting session is one of the reasons for deteriorating a quality of a network, because the transferring data via the chatting session inefficiently and unconditionally transfers data.

### SUMMARY

According to at least one aspect of the present disclosure, there is provided a content server using a hypertext transfer protocol (HTTP). The content server includes a server transceiver unit configured to transmit and receive data; a server storage unit configured to store one or more files; and a server control unit configured to receive a file from a transmitting terminal through the server transceiver unit by using the HTTP, store the received file in the server storage unit, and transmit file link information on the stored file to the transmitting terminal through the server transceiver unit, wherein the server control unit is further configured to, when a request for the file corresponding to the file link information is received through the server transceiver unit from a receiving terminal that receives the file link information from a message server, provide the stored file to the receiving terminal.

According to at least one aspect of the present disclosure, there is provided a terminal that includes a terminal transceiver unit configured to transmit and receive data; a terminal storage unit configured to store one or more files; and a terminal control unit configured to upload a file among the files stored in the terminal storage unit to a content server through the terminal transceiver unit by using an HTTP, receive file link information on the uploaded file from the content server through the terminal transceiver unit, and transmit the received file link information to a receiving terminal through a message server such that the receiving terminal downloads the file from the content server by using the transmitted file link information.

According to at least one aspect of the present disclosure, there is provided a non-transitory computer readable recording medium recording a program for executing: uploading, by a transmitting terminal, a file to a content server by using an HTTP POST message; receiving, by the transmitting terminal, file link information on the uploaded file from the content server; and transmitting, by the transmitting terminal, the received file link information to a receiving terminal through a message server such that the receiving terminal downloads the file from the content server by using the file link information.

### BRIEF DESCRIPTION OF DRAWINGS

FIG. 1 is a schematic block diagram of a file transfer system using an HTTP according to some embodiments of the present disclosure.

FIG. 2 is a schematic block diagram of a message server of FIG. 1.

FIG. 3 is a schematic block diagram of a content server of FIG. 1.

FIG. 4 is a schematic block diagram of a file transfer terminal of FIG. 1.

FIG. 5 is a flowchart of a file transfer method using an HTTP according to some embodiments of the present disclosure.

### DETAILED DESCRIPTION

Hereinafter, preferred embodiments of the present disclosure will be described in detail with reference to the accompanying drawings such that a person skilled in the art may easily carry out the embodiments of the present disclosure. Moreover, detailed descriptions related to well-known functions or configurations will be ruled out in order not to unnecessarily obscure subject matters of the present disclosure.

In addition, like reference numerals refer to like elements throughout the specification.

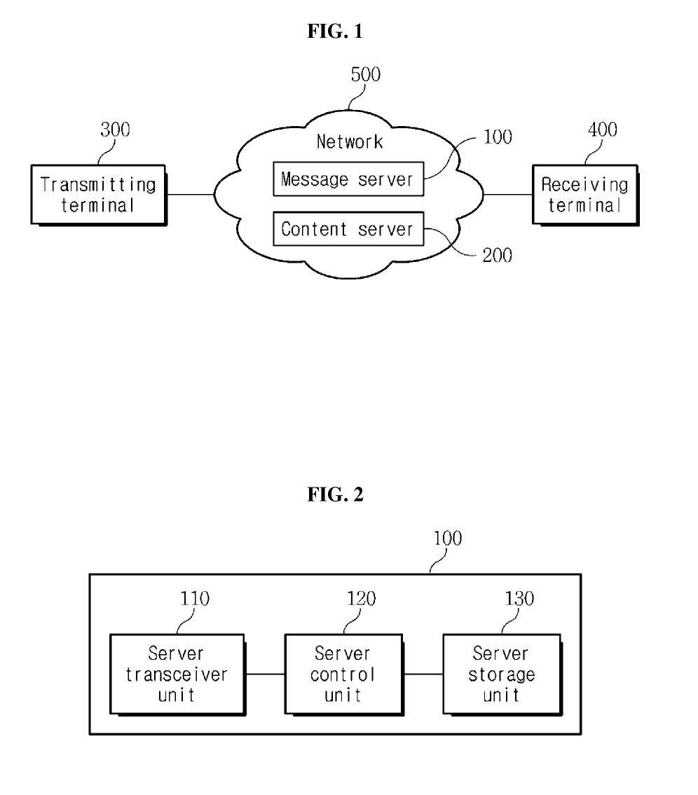

FIG. 1 is a schematic block diagram of a chatting message transfer system according to some embodiments of the present disclosure.

Referring to FIG. 1, the chatting message transfer system according to some embodiments of the present disclosure includes a message server 100, a content server 200, a transmitting terminal 300, a receiving terminal 400, and a network 500.

The network 500 is a communication network for transmitting and receiving data to exchange information among the transmitting terminal 300, the receiving terminal 400, and the message server 100.

In some embodiments, the network 500 of the present disclosure includes an Internet multimedia subsystem (IMS) infrastructure for providing an IP-based multimedia application service. Also, the network 500 includes one or more wired or wireless networks that have been developed and commercialized or will be developed, depending on a type of the transmitting terminal 300 or the receiving terminal 400.

In some embodiments, the network 500 of the present disclosure includes a device such as a call state control function (CSCF) for performing session exchange and call control.

In some embodiments, each of the transmitting terminal 300 and the receiving terminal 400 is a terminal capable of supporting a chatting function to a user, which is one of wired and wireless terminals such as a mobile phone, a smartphone, a home appliance, a computer, and a notebook.

The transmitting terminal 300 of the present disclosure includes a communication interface for transferring a chatting message or data to the receiving terminal 400 or uploading a file to the content server 200. The transmitting terminal 300 of the present disclosure also includes an input device for inputting the chatting message, and a display device for displaying the received chatting message.

The receiving terminal 400 of the present disclosure includes a communication interface for receiving a chatting message or data from the transmitting terminal 300 or downloads a file from the content server 200. The receiving terminal 400 of the present disclosure also includes an input device for inputting the chatting message, and a display device for displaying the received chatting message.

The message server 100 is a chatting server that transfers chatting messages and provides an instant messaging (1M) service between the transmitting terminal 300 and the receiving terminal 400 in the network 500.

The message server 100 of the present disclosure identifies subscribed users with user identifiers. The message server 100 of the present disclosure manages a state, a receive mode, a message receiver list, and subscriber environment information for each subscribed user. The message server 100 of the present disclosure also manages an IM conversation session for delivering 1M conversation messages (i.e., chatting messages) between users who is on-line to the Internet.

In some embodiments, the message server 100 performs session initiation protocol (SIP) call processing, message session relay protocol (MSRP) relay, and so on, and thus, the message server 100 provides a chatting service between the transmitting terminal 300 and the receiving terminal 400.

The transmitting terminal 300 uploads an internal file to the content server 200 using an HTTP POST message. Here, POST is an HTTP method used for a client to send any data to a server. Thus, the HTTP POST message is a message for sending data from the client to the server.

When receiving a file from the transmitting terminal 300, the content server 200 stores the received file and transmits file link information on the stored file to the transmitting terminal 300.

For example, the content server 200 stores the received file in at least one of an internal storage and a separate external server capable of communicating data with the network 500.

In some embodiments, the content server 200 transmits the file link information to the transmitting terminal 300 using an HTTP 200 OK response message. The HTTP 200 OK response message is a response message for successful HTTP request. The actual response message depends on the request method used. In a GET request, the response message contains an entity corresponding to the requested resource. In a POST request message the response contains an entity describing or containing the result of the action.

In addition, the file link information transmitted by the content server 200 to the transmitting terminal 300 includes, for example, information such as a uniform resource locator (URL) or uniform resource indicator (URI) of where the file is stored.

When receiving the file link information from the content server 200, the transmitting terminal 300 transmits the file link information to the message server 100, and the message server 100 transmits the file link information to the receiving terminal 400.

In this case, the transmitting terminal 300 transmits the file link information on the stored file to the receiving terminal 400 using an SIP MESSAGE method.

When receiving the file link information from the transmitting terminal 300 via the message server 100, the receiving terminal 400 requests the file from the content server 200 using the file link information and downloads the file.

In this case, the receiving terminal 400 transmits an HTTP GET message to the content server 200, receives a 200 OK message in response to the transmit, and downloads the file.

When the downloading is completed, the receiving terminal 400 transmits a delivered notification message to the transmitting terminal 300 via the message server 100 using an SIP MESSAGE method.

The HTTP GET message is a message based on an HTTP method used to request the server to find a resource designated by a URL, etc. included in an HTTP request line and transfer the found resource to a client.

In this file transmit process, a file is not directly transmitted between the transmitting terminal 300 and the receiving terminal 400, but a file is indirectly transmitted using the message server 100 and the content server 200.

In this case, the receiving terminal 400 does not request downloading of the file from the message server 100 as soon as receiving the file link information from the transmitting terminal 300, but attempts to download the file when appropriate in consideration of a network load or a resource state of the receiving terminal 400, thereby enabling more efficient downloading.

In addition, according to the present disclosure, the file link information is delivered to the receiving terminal 400 using the SIP MESSAGE method without establishing a separate session for file transfer or a chatting session for delivering the file link information.

For example, in a case where a photograph stored in the transmitting terminal 300 is to be transferred to the receiving terminal 400, if a separate transfer session or chatting session is not established between the transmitting terminal 300 and the receiving terminal 400, then according to a technical concept of the present disclosure, the file is transferred to the receiving terminal 400 using an HTTP without session establishment, thereby enhancing efficiency of using resources.

The function and operation of the message server 100 for storing and providing a file according to the present disclosure is described in detail below with reference to FIG. 2.

FIG. 2 is a schematic block diagram of a message server of FIG. 1.

Referring to FIG. 2, a message server 100 according to some embodiments of the present disclosure includes a server transceiver unit 110, a server control unit 120, and a server storage unit 130.

The server transceiver unit 110 includes an interface for transmitting and receiving data over the network 500.

In some embodiments, the server storage unit 130 is a storage for storing information included in data and a message transmitted and received from the transmitting terminal 300. The server storage unit 130 of the present disclosure is at least one of an internal storage of the message server 100, and a data storage server located outside the message server 100 and configured to communicate data with the message server 100.

In some embodiments, the server control unit 120 serves to control overall operations of the message server 100 including the server transceiver unit 110 and the server storage unit 130. To this end, the server control unit 120 includes a processor and an application program storage.

In some embodiments, the server control unit 120 provides a chatting service between the transmitting terminal 300 and the receiving terminal 400 by transmitting and receiving a message using the server transceiver unit 110.

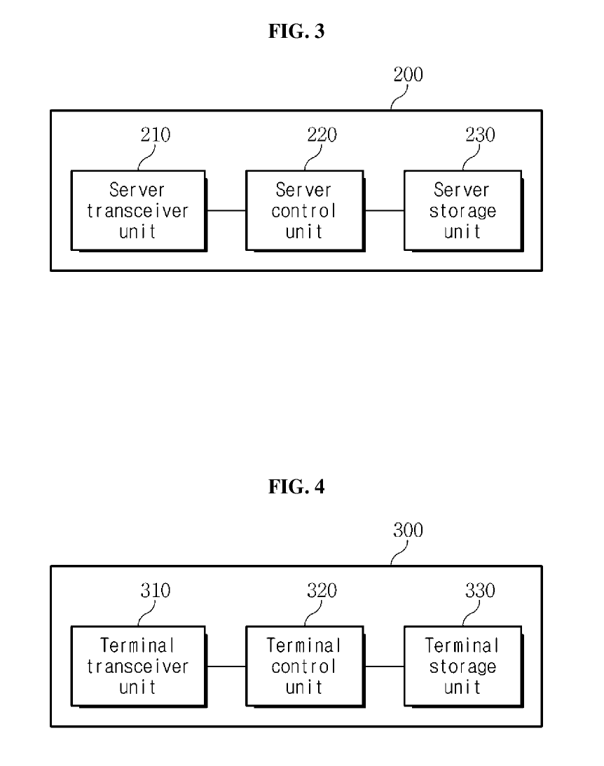

FIG. 3 is a schematic block diagram of a content server of FIG. 1.

Referring to FIG. 3, a content server 100 according to some embodiments of the present disclosure includes a server transceiver unit 210, a server control unit 220, and a server storage unit 230.

The server transceiver unit 210 includes an interface for transmitting and receiving data over the network 500.

In some embodiments, the server storage unit 230 is a place for storing a file transferred to the transmitting terminal 300. The server storage unit 230 of the present disclosure includes at least one of an internal storage of the content server 200, and a data storage server located outside the content server 200 and configured to transmit and receive data to and from the content server 200.

In some embodiments, the server control unit 220 serves to control overall operations of the message server 100 including the server transceiver unit 210 and the server storage unit 230. To this end, the server control unit 220 includes a processor and an application program storage. According to the present disclosure, when the server control unit 220 receives a file from the transmitting terminal 300 through the server transceiver unit 210, the server control unit 220 stores the file in a user directory of the server storage unit 230.

In this case, the server control unit 220 receives the uploaded file through an HTTP POST message from the transmitting terminal 300. Then, the server control unit 220 transmits file link information on the file stored in the server storage unit 230 to the transmitting terminal 300 through the server transceiver unit 210.

For example, the server control unit 220 transmits the file link information to the transmitting terminal 300 using an HTTP 200 OK message.

The file link information transmitted by the server control unit 220 to the transmitting terminal 300 includes, for example, information such as a uniform resource locator (URL) or uniform resource indicator (URI) of where the file is stored.

Subsequently, the server control unit 220 receives a request to transmit the file stored in the server storage unit 230 from the receiving terminal 400 through the server transceiver unit 210.

In this case, for example, the server control unit 220 receives the HTTP GET message including at least one of URL and URI information on the stored file from the receiving terminal 400, retrieves a file corresponding to the at least one of URL and URI information, and transmits the file to the receiving terminal 400.

As such, the content server 200 of the present disclosure performs a function of storing a file uploaded by the transmitting terminal 300 according to a control of the server control unit 120 and then providing the stored file according to a download request of the receiving terminal 400.

The function of the server control unit 120 enables a file to be indirectly transferred using the content server 200, instead of enabling the file to be directly transferred between the transmitting terminal 300 and the receiving terminal 400.

The function and operation of the transmitting terminal 300 for uploading a file to the content server 200 and transmitting file link information to the receiving terminal 400 according to the present disclosure is described in detail below with reference to FIG. 4.

FIG. 4 is a schematic block diagram of a transmitting terminal of FIG. 1.

Referring to FIG. 4, the transmitting terminal 300 according to some embodiments of the present disclosure includes a terminal transceiver unit 310, a terminal control unit 320, and a terminal storage unit 330.

The terminal transceiver unit 310 includes an interface for transmitting and receiving data over the network 500.

The terminal storage unit 330 stores a file uploaded to the message server 100.

The terminal control unit 320 serves to control overall operations of the transmitting terminal 300 including the terminal transceiver unit 310 and the terminal storage unit 330. To this end, the terminal control unit 320 includes a processor and an application program storage.

According to the present disclosure, when a user manipulates the transmitting terminal 300 to transmit an internally stored specific file to the receiving terminal 400, the terminal control unit 320 uploads the file stored in the terminal storage unit 330 to the content server 200 through the terminal transceiver unit 310.

In this case, the terminal control unit 320 allows the file to be transmitted to the content server 200 using the HTTP POST message.

When uploading the file to the content server 200, the terminal control unit 320 receives file link information on the file through the terminal transceiver unit 310.

In this case, the terminal control unit 320 receives the file link information included a body of the 200 OK message in response to the HTTP POST message transmitted to the content server 200.

Then the terminal control unit 320 transmits the file link information received from the content server 200 to the message server 100 through the terminal transceiver unit 310, and the message server 100 transmits the file link information to the receiving terminal 400 again.

In this case, the terminal control unit 320 delivers the file link information to the receiving terminal 400 through the message server 100 using the SIP MESSAGE method.

Thus, the terminal control unit 320 uploads the file to the content server 200 without establishing a separate file transfer session or a chatting session for delivering the file link information.

In addition, conveniently, the file link information is delivered for the receiving terminal 400 to download the file from the content server 200, by using the SIP MESSAGE method, without establishment of a separate session.

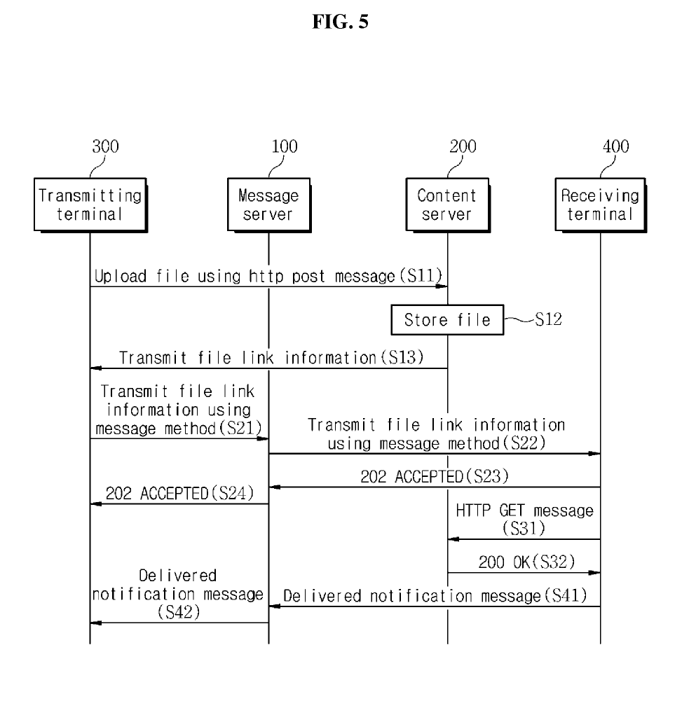

The process of delivering a file retained by the transmitting terminal 300 to the receiving terminal 400 according to the present disclosure is described in detail below with reference to FIG. 5.

FIG. 5 is a flowchart of a file transfer method using an HTTP according to some embodiments of the present disclosure.

Referring to FIG. 5, the transmitting terminal 300 uploads an internally stored file to the content server 200 using an HTTP POST message in step S11. In step S11, the transmitting terminal 300 uploads the file using the HTTP without establishing a separate file transfer session or a chatting session.

The content server 200 stores the file received in step S11 in at least one of an internal storage and a separate storage server, in step S12, and transmits file link information on the stored file to the transmitting terminal 300, in step S13. In step S13, for example, the content server 200 transmits the file link information contained in a body of a 200 OK message to the transmitting terminal 300 in response to the HTTP POST message received, in step S11.

In this case, the file link information transmitted from the content server 200 to the transmitting terminal 300 includes, for example, information such as a URL or URI indicating where the file is stored.

When receiving the file link information in step S13, the transmitting terminal 300 transmits the file link information to the message server 100, in step S21. The message server 100 transmits the file link information to the receiving terminal 400 again, in step S22.

In the transmit processes of steps S21 and S22, for example, the file link information is transmitted using the SIP MESSAGE method.

The SIP MESSAGE is an SIP method used to deliver a message to a URI indicating a partner terminal, which may be delivered irrespective of session establishment between of the transmitting terminal 300 and the receiving terminal 400.

When receiving the file link information, in step S22, the receiving terminal 400 transmits a 202 ACCEPTED response message to the message server 100, in step S23. The message server 100 transmits the 202 ACCEPTED response message to the transmitting terminal 300 again, in step S24.

The 202 ACCEPTED is a response code indicating that the receiving terminal 400 has received a request but, has not determined whether to process the request. In the present disclosure, the 202 ACCEPTED is a response code indicating that the receiving terminal 400 has received the file link information, but has not yet determined whether to download the file.

When receiving the file link information, in step S21, the receiving terminal 400 transmits an HTTP GET message to the content server 200 using information such as a URL or URI included in the link information, in step S31, and downloads the file during a process of receiving a 200 OK response from the content server 200, in step S32.

In this case, in step S31, the receiving terminal 400 does not request downloading of the file immediately after receiving the file link information in step S22, but attempts to download the file when appropriate in consideration of a network load or a resource state of the receiving terminal 400, thereby transferring the file more efficiently.

When the downloading is completed, the receiving terminal 400 transmits a delivered notification message to the message server 100 through the SIP MESSAGE method, in step S41. Thus, the message server 100 transmits the delivered notification message received through the SIP MESSAGE method to the transmitting terminal 300, in step S42.

In this way, the transmitting terminal 300 does not transmit an internal file to the receiving terminal 400 directly, but uploads the internal file to the content server 200 on the network 500. Thus, the receiving terminal 400 may download the file from the content server 200 using the file link.

According to the present disclosure, when there is a file in the transmitting terminal 300 and the file is desired to be transferred to the receiving terminal 400, the file is transferred to the receiving terminal 400 using the HTTP without establishment of a separate session, thereby enhancing efficiency of using resources.

According to the present disclosure, a file is transferred, by using the HTTP between the transmitting terminal and the receiving terminal. The file is also received, when more appropriate timing, not as soon as the transmitting terminal transfers the file. Thus, convenience of a user is enhanced, by using the receiving terminal and transferring. In view of a service provider, transferring data more efficiently uses network resources.

Furthermore, when a file is transferred to a plurality of receiving terminals, it is prevented that a file transfer rate or transfer success rate from depending on a terminal having the poorest network load or resource state and transfer the file to each terminal independently. Thus, a data transfer efficiency is improved.

In some embodiment, a program for executing the process of FIG. 5 is recorded in a non-transitory computer readable recording medium. The non-transitory computer readable recording medium includes one or more physical, actual storage devices. Examples of physical, actual storage devices include, but are not limited to, magnetic media such as, a hard disk, a floppy disk, and a magnetic tape, optical media such as a CD-ROM and a DVD, magneto-optical media such as a floptical disk, and a hardware device configured especially to store and execute a program, such as a ROM, a RAM, a solid state drive, and a flash memory.

While the disclosure has been shown and described with reference to preferred embodiments thereof, it will be understood by those skilled in the art that such description is for illustrative purposes only and various changes and modifications may be made without departing from the spirit and scope of the disclosure as defined by the appended claims. Therefore, all such changes and modifications, and the equivalents thereof, will be considered to be within the spirit and scope of the disclosure.

What is claimed is:

1. A content server using a hypertext transfer protocol (HTTP), the content server comprising:
a server transceiver unit configured to transmit and receive data;
a server storage unit configured to store one or more files; and
a server control unit configured to
receive a file from a transmitting terminal through the server transceiver unit by using the HTTP,
store the received file in the server storage unit, and
transmit file link information on the stored file to the transmitting terminal through the server transceiver unit,
wherein the server control unit is further configured to, when a request for the file corresponding to the file link information is received through the server transceiver unit from a receiving terminal that receives the file link information from a message server, provide the stored file to the receiving terminal.

2. The content server of claim 1, wherein the server control unit is further configured to receive the file from the transmitting terminal by using an HTTP POST message.

3. The content server of claim 1, wherein the server control unit is further configured to transmit an HTTP 200 OK message including the file link information to the transmitting terminal.

4. The content server of claim 1, wherein when a request for the file is received using an HTTP GET message from the receiving terminal, the server control unit is further configured to provide the stored file to the receiving terminal.

5. The content server of claim 1, wherein the file link information includes at least one of a uniform resource locator or a uniform resource indicator.

6. The content server of claim 1, wherein the file link information is delivered to the receiving terminal by using a SIP MESSAGE method without establishing a separate session for file transfer or a chatting session for delivering the file link information.

7. A terminal, comprising:
a terminal transceiver unit configured to transmit and receive data;
a terminal storage unit configured to store one or more files; and
a terminal control unit configured to
upload a file among the files stored in the terminal storage unit to a content server through the terminal transceiver unit by using a hypertext transfer protocol (HTTP),
receive file link information on the uploaded file from the content server through the terminal transceiver unit, and
transmit the received file link information to a receiving terminal through a message server such that the receiving terminal downloads the file from the content server by using the transmitted file link information.

8. The terminal of claim 7, wherein the terminal control unit is further configured to transmit the file to the content server by using an HTTP POST message.

9. The terminal of claim 7, wherein the terminal control unit is further configured to transmit the file link information to the receiving terminal through the message server by using a session initiation protocol (SIP) MESSAGE method.

10. The terminal of claim 7, wherein the file link information includes at least one of a uniform resource locator or a uniform resource indicator.

11. A file transfer method performed by a terminal, the method comprising:
uploading a file to a content server by using an HTTP POST message;
receiving a file link information on the uploaded file from the content server; and
transmitting the received file link information to a receiving terminal through a message server such that the receiving terminal downloads the file from the content server by using the file link information.

12. A non-transitory computer readable recording medium recording a program for causing, when executed by a transmitting terminal, the transmitting terminal to execute:
uploading, by the transmitting terminal, a file to a content server by using a hypertext transfer protocol (HTTP) POST message;
receiving, by the transmitting terminal, file link information on the uploaded file from the content server; and
transmitting, by the transmitting terminal, the received file link information to a receiving terminal through a message server such that the receiving terminal downloads the file from the content server by using the file link information.

13. The non-transitory computer readable recording medium of claim 12, wherein the file link information includes at least one of a uniform resource locator or a uniform resource indicator.

14. The non-transitory computer readable recording medium of claim 12, wherein the file link information is delivered to the receiving terminal by using a SIP MESSAGE method without establishing a separate session for file transfer or a chatting session for delivering the file link information.
